(19) United States
(12) Patent Application Publication
(10) Pub. No.: US 2015/0112953 A1
(43) Pub. Date: Apr. 23, 2015

(54) EXPANDABLE METHOD AND SYSTEM FOR STORING AND USING FACT DATA STRUCTURE FOR USE WITH DIMENSIONAL DATA STRUCTURE

(71) Applicant: Omnition Analytics, LLC, Jacksonville, FL (US)

(72) Inventors: Kishore Nair, Jacksonville, FL (US); Eric T Shannon, Fernandina Beach, FL (US)

(73) Assignee: Omnition Analytics, LLC, Jacksonville, FL (US)

(21) Appl. No.: 14/495,184

(22) Filed: Sep. 24, 2014

Related U.S. Application Data
(60) Provisional application No. 61/893,995, filed on Oct. 22, 2013.

(51) Int. Cl. G06F 17/30

(52) U.S. Cl. CPC G06F 17/30289; G06F 17/30592
USPC 707/694; 707/600

(57) ABSTRACT

The ability to store fact data and related dimensions is improved by having a single fact data structure connected to a plurality of dimensional structures via a bridge structure, which take the position of the data structure.

This application claims priority of U.S. provisional application No. 61/893,995 filed on Oct. 22, 2013 and is incorporated in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to storing and retrieving a plurality of fact data in a single data structure in combination with a plurality of dimensional data structures. In particular, it relates to the coupling of fact data structure and dimensional data structures utilizing a bridge data structure. The invention further relates to bridging data structure for connecting multi-dimensional data and fact data, and how to process such data within a single data structure.

2. Description of Related Art

The storage of data in a complex computer system is typically accomplished in multiple data storage units with supporting dimensions replicated for each level of granularity of data. Fact data is typically coupled to dimensional data which is inherently fast, but creates other problems which are continually worsening as programs get larger. Memory management in such a format space wasting manner causes a slowdown in the processing of information, and also causes a waste of memory and database space.

Typically, the way things are dealt with is by faster chips and larger and larger memories and data bases. However, as all programs get more complex, the difficulty in managing these types of systems increases, and only so much reduction in problems has been achieved. There is still a need for means and methods for reducing these slowdowns and waste problems on the software programming and database programming levels.

### BRIEF SUMMARY OF THE INVENTION

The present invention relates to a method of achieving an improvement in the above identified problems by placing a copy of the fact data in a database, and connecting the database to n-dimensional granularity, without replication of information, by use of a bridge data structure. It also allows for a database type system structure, which in turn allows for the architect or data modeler of the database to not need to know all the dimensions before creating a data model. It is therefore uniquely expandable to accommodate n-dimensions without linking or adding repeat fact data.

Accordingly, one embodiment of the present invention relates to a data system, comprising a single fact data structure and a plurality of dimensional data structures, capable of adding additional dimensional data structures without having to add additional fact data structures. And comprising associating the fact data and dimensional data structures together by coupling them each directly to a bridge data structure, wherein each dimensional structure is added to the bridge data structure, utilizing a dimension key entry in the bridge data structure to associate at least one of the facts with the dimensional structure.

In yet another embodiment of the present invention, there is a bridge data structure for use in a data storage system having a single fact data structure and a plurality of dimensional data structures, wherein the bridge data structure links the fact data structure and the plurality of dimensional data structures by coupling them each directly to a bridge data structure. And wherein each dimensional structure is added to the bridge data structure utilizing a dimension key entry in the bridge data structure to associate at least one of the facts with the dimensional structure.

### BRIEF DESCRIPTION OF THE DRAWINGS

FIG. 1 is an omnition FDIM and rules object model in Java.

FIG. 2 is a FDIM physical implementation in an ODBC compliant database.

FIG. 3 is a FDIM with rules data store in an ODBC compliant database.

FIG. 4 is a FDIM CMS inpatient charge data.

FIG. 5 is a rules store.

FIG. 6 is hierarchical structure.

FIG. 7 is a time hierarchy where Q is a quarter.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitations thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein a “data system” refers to an interactive system on a computer, i.e. in the active memory of a computer, wherein the system manipulates the relationship of fact data and dimensional data which are in some fashion related. In prior art data systems the fact and dimensional data are directly connected or coupled, while in the present invention they are decoupled, linked via a bridge which is described following. Examples include, but are not limited to, databases such as Open Database Connectivity (ODBC) and object data software such as Java. As used herein, the term “computer” refers to any digital storage or processing such as a personal computer, server, web site, PDA, net book, phone or the like that has digital processing power for achieving the uploading of digital information and processing a data system of the present invention.

As used herein a “single fact data structure” refers to a collection of a plurality of facts contained within a single data structure. A fact can either be a numerical value or character based value. Additionally, it could be a collection of values or an object.

As used herein a “dimensional data structure” refers to a structure comprising one or more dimensional facts such as a product, department, patient, customer, time or the like. In general, anything that is quantifiable for example by the fact data in the fact data structure.

As used herein “coupling” refers to a direct connection between a fact data structure and a dimensional data structure.

As used herein a “bridge data structure” is a structure which sits where a fact data structure would sit in the prior databases but the facts are not stored there. Instead, just the intersections of the dimensions are stored. Each unique intersection is assigned an intersection ID and can reference one or more facts in the separate fact data structure. As little as two, or up to all, of the dimensions may be referenced in an intersection in order to store or read a fact from the fact data structure.

As used herein a “dimension key entry or primary key” refers to an entry in the bridge data structure which identifies each of the dimensional data structures and which facts are associated therewith.

As used herein a “flex dimensional information storage model” or FDIM refers to the novel data system of the present system, where facts are maintained within a single fact data structure with just raw values and a connection to the bridge data structure. The dimensional data structures (any number of dimensions added at any time) are also connected to the bridge structure, thus connecting the fact and dimensional data structures in any level of granularity. This allows for different levels of granularity to be associated with one or more facts and type dimension, which allows for infinite types of measures to be stored in a single fact data structure. Thus, any type of measure at any level of granularity in a single fact data structure is achieved. For example, if you want to add a Diagnosis Dimension to the system and track measures associated with it, you would simply add a new data structure called T_DIAGNOSIS_DIM with a primary key of DIAGNOSIS_ID and add the primary key to the T_BRIDGE data structure as a foreign key. The fact data structure (T_METRIC_FACT) is unchanged and is now ready to accept the new measures associated with the Cancer Dimension. This allows for a single fact data structure to accommodate as many dimensions as needed. It also allows for the fact that an architect or data modeler does not need to know all the dimensions before creating the data model. It is expandable to accommodate infinite or n Dimensions.

As used herein “levels of granularity” refers to the complexity or level of information of the dimensional data of the system. N levels of granularity in a single data structure is achieved by de-coupling the dimensions from the facts. Being grain agnostic allows the FDIM to share dimensions across multiple fact types. This is significant because it allows the facts stored at different grains to be relevant to each other. For example, if we had two facts, one called Total Sales and another called Regional Sales; Total Sales is stored at the intersection of Time, Product, Customer and Department, while Regional Sales is stored at the intersection of Time, Product, Customer and Sales Region. These two fact types share the common dimensions of Time, Product and Customer and differ in grain as a result of the uncommon dimensions of Department and Sales Region.

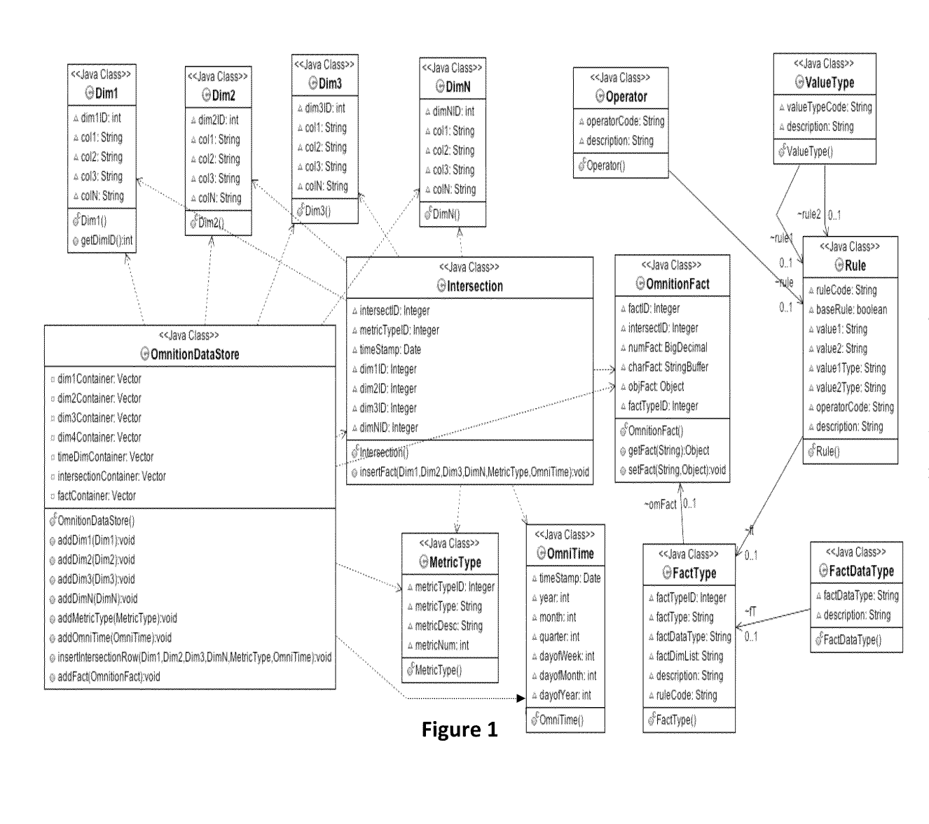

Now referring to the figures, examples are shown in the figures and a general discussion of the entire system follows. The discussion refers to the examples in the FIGS. 1-7 and generally refers back and forth.

FIG. 1 shows a physical implementation of the FDIM in a Java Environment. The example illustrates usage of a fact data structure to a dimension data structure with multiple (n) dimensions associated with it, a granularity data structure that allows for multiple levels of granularity and a Type Dimension that allows for ‘n’ types of measures.

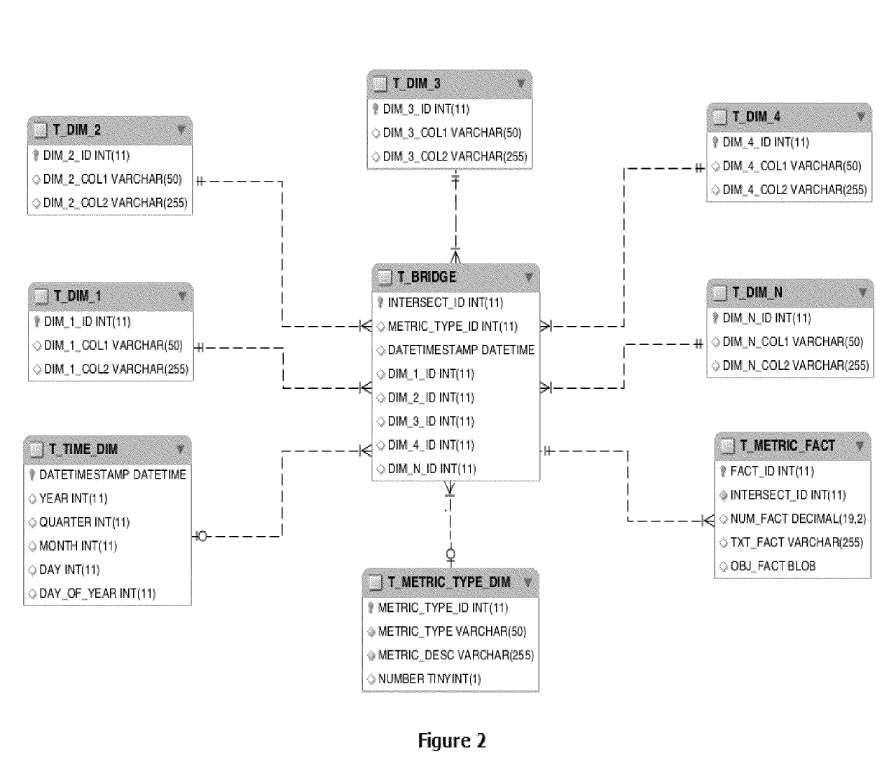

FIG. 2 shows a physical implementation in an ODBC compliant database. The example illustrates usage of a fact data structure to a dimension data structure with multiple (n) dimensions associated with it, a granularity data structure that allows for multiple levels of granularity and a Type Dimension that allows for ‘n’ types of measures.

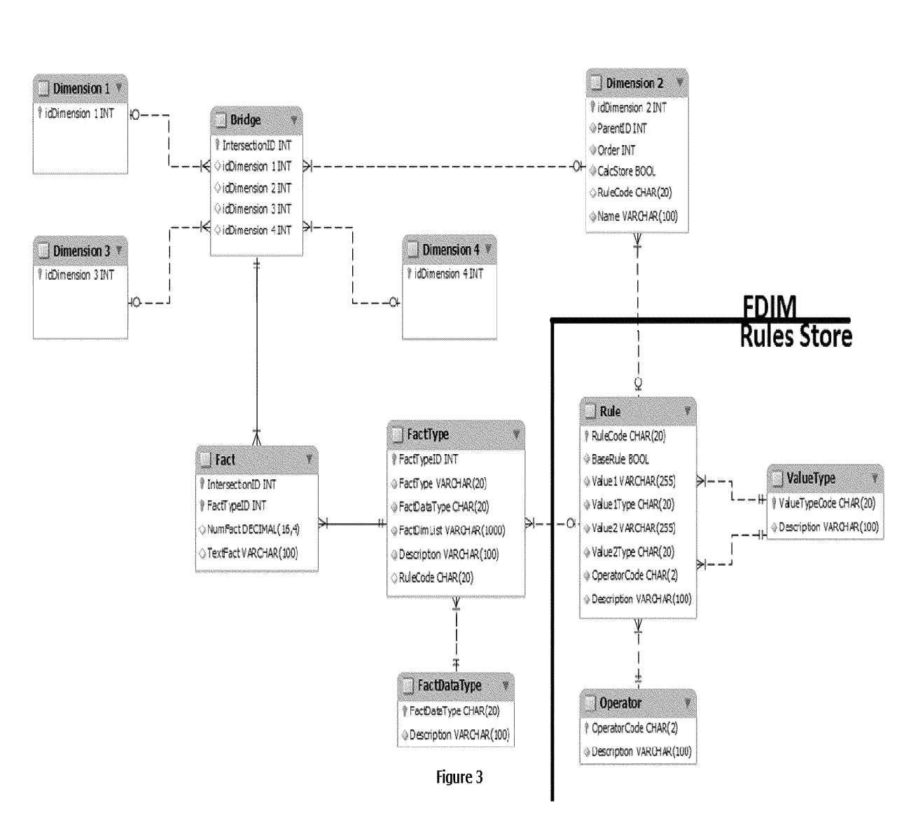

FIG. 3 shows a physical example implementation of FDIM with the Rules Data Store in an ODBC compliant database.

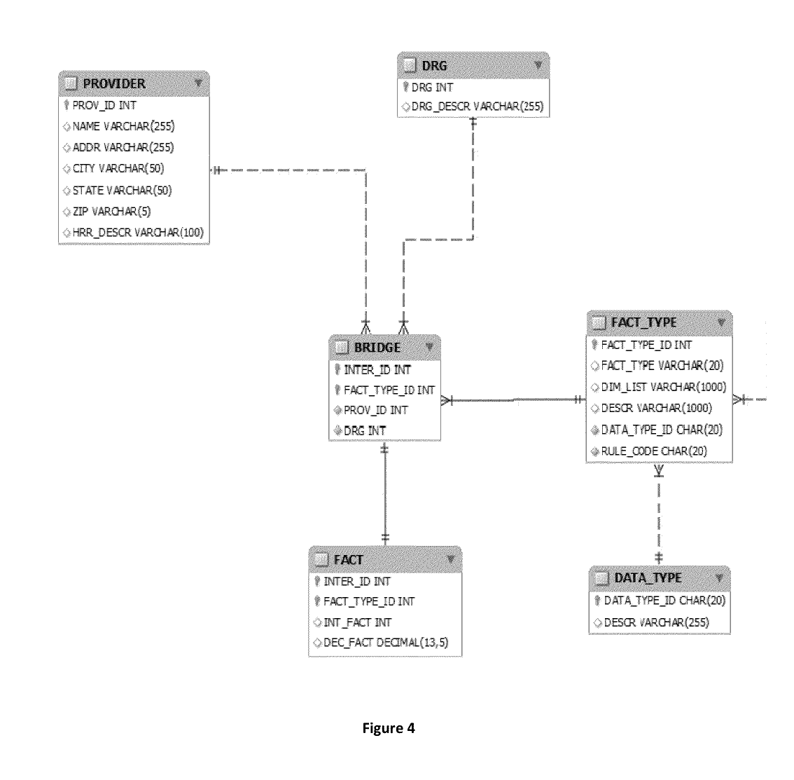

FIG. 4 illustrates the CMS Inpatient Charge Data implemented as an FDIM structure.

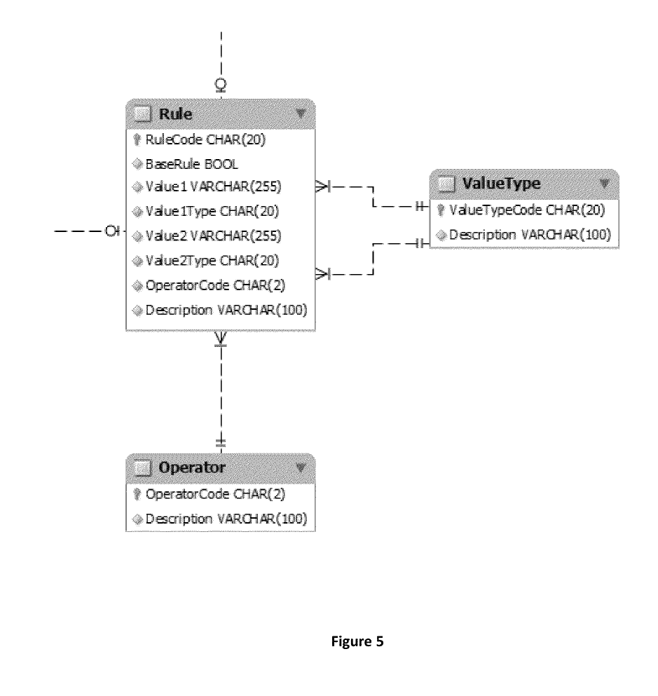

FIG. 5 illustrates a physical implementation of the Rules Data Store in an ODBC compliant database.

The entire system in operational mode is comprised of three main components; the FDIM, a rules data store, and software that facilitates the operation and maintenance of the entire system. The FDIM provides the capability of storing many multi-dimensional measures at any grain, all within the same database. The rules data store is comprised of a rules data store and software that is used to store and process rules. Rules tell the software how to process the data. There are two types of rules; Hierarchical Processing rules, which allows for OLAP (online analytical processing) like processing, and Derived Fact rules which allows for run-time calculated facts. The software will provide an interface for users to run reports against the database, set up and process the Derived Facts, and set up and process the hierarchical processing rules.

The fact data structure is where the data that is to be measured against the dimensions is stored. Each fact is identified by its intersection ID and its Fact Type ID. The intersection tells where the data resides and the fact type indicates what is being measured. Because of this, an infinite number of facts may be stored at a given intersection of dimensions. This data structure can be comprised for example of the following columns:

| Field Name | Description |
|---|---|
| IntersectionID | The intersection defined in the Bridge data structure. |
| FactTypeID | This is the ID of the fact type entry that determines what |
| | the fact is measuring and the data type of the fact. |
| NumFact | This stores a numerical fact. The size and precision of |
| | this field will be determined by the intended use. |
| TextFact | This stores a textual fact. The size of this field will be |
| | determined by the intended use. |
| ObjectFact | This stores an object (a collection of facts) |

The FactType data structure stores information about fact types. A fact type defines what kind of data is stored in a row in the fact data structure. Each fact type represents a separate measure that the database can store and process.

| Field Name | Description |
|---|---|
| FactTypeID | This is the unique identifier for a fact type. This key is |
| | assigned by the database. |
| FactType | This is a user defined mnemonic that refers to a unique |
| | fact type |
| FactDataType | This references the FactDataType data structure and |
| | identified a defined type that the software can process. |
| FactDimList | This contains a comma delimited list of the required |
| | dimensions needed to access this fact. |
| Description | This contains a description of the fact type. |
| RuleCode | This column references a rule stored in the Rules data |
| | structure that has been defined for a Derived Fact. |
| | Derived facts are discussed in section 3.3.3. |

The FactDataType Data structure stores information about fact data types. The data type tells the software which field to pull the fact value from in the fact data structure (NumFact or TextFact). Initially, this data structure can be populated with the values of INTEGER, STRING and DECIMAL although more may be added as necessary.

| Field Name | Description |
|---|---|
| FactDataType | This is a mnemonic that the software will recognize and |
| | use to determine the data type to use when processing a |
| | fact value. |
| Description | This contains a description of the fact data type. |

Since the data structure of the FDIM varies from the standard multi-dimensional model, we will demonstrate an example of the retrieving and storing of factual and dimensional data, as well as adding facts and dimensions. For this demonstration, we will use a very simple FDIM database that was modeled after CMS Inpatient Charge Data, FY2011. This is a Public Use File (PUF) that can be downloaded freely from: http://www.cms.gov/Research-Statistics-Data-and-Systems/Statistics-Trends-and-Reports/Medicare-Provider-Charge-Data/Inpatient.html. One can refer to the FIGS. 1 through 7 to help in the understanding of the FDIM models.

In this example, we have two dimensions; Provider and DRG, so the Bridge table has four fields in order to describe the intersections and the fact type. The PROV_ID, DRG and INTER_ID fields describe the intersection, while fact type describes the type of fact stored at the intersection. There are three fact types stored in this model, they are:
Total Discharges (TOT_DISCH)—This fact is an integer and will be stored in the INT_FACT field of the FACT table. This is defined as “The number of discharges billed by the provider for inpatient hospital services”.
Average Covered Charges (AVG_CVRD_CHGS)—This fact is a decimal and will be stored in the DEC_FACT field of the FACT table. This is defined as “The provider's average charge for services covered by Medicare for all discharges in the DRG. These will vary from hospital from hospital because of differences in hospital charge structure.”
—Average Total Payments (AVG_TOT_PMTS)—This fact is a decimal and will be stored in the DEC_FACT field of the FACT table. This is defined as “The average of Medicare payments to the provider for the DRG, including the DRG amount, teaching, disproportionate share, capital and outlier payments for all cases. Also included are co-payment and deductible amounts that the patient is responsible for”.

For all of the fact types listed above, the DIM_LIST has the value of “PROVIDER,DRG”. This tells us that both of the dimensions must be referenced when retrieving or storing all of the facts in this database. Knowing the above, it is now possible to devise SQL statements intended to store and retrieve data from this example.

Storing a fact is relatively straight forward. The biggest concern is that when inserting a fact into an intersection, all of the values for dimensions listed in the DIM_LIST must be specified when defining the intersection. In this case we are going to store the value 23 at the intersection of PROV_ID=10001 and DRG=39 for the fact type of TOT_DISCH.

When storing a fact, the first thing that needs to be done is determining whether or not the intersection is defined. To do this the following SQL must be executed:

SELECT

COUNT(INTER_ID) AS CNT

FROM

CMS_MED_PROV_CHRG.BRIDGE br,
CMS_MED_PROV_CHRG.FACT_TYPE ft

WHERE

br.FACT_TYPE_ID = ft.FACT_TYPE_ID AND
br.PROV_ID = 10001 AND
br.DRG = 39 AND
ft.FACT_TYPE = ‘TOT_DISCH’

Where 10001 is the ID of the provider that we are storing this fact about, 39 is the DRG for which this fact refers to and ‘TOT_DISCH’ is the fact type for the fact that is being stored.

If the above returns a value of 0 in CNT, then the intersection must be created. To do this, execute the following SQL:

INSERT INTO CMS_MED_PROV_CHRG.BRIDGE(

INTER_ID,
FACT_TYPE_ID,
PROV_ID,
DRG)

VALUES (
NULL,
1,

10001,

39)

Where INTER_ID is left null as it is an auto increment field, 1 is the FACT_TYPE_ID for the FACT_TYPE ‘TOT_DISCH’ and 10001 and 39 for the same reasons above.

Once an intersection has been defined, inserting a value into the FACT table is a simple INSERT statement:

INSERT INTO CMS_MED_PROV_CHRG.FACT (

INTER_ID,
FACT_TYPE_ID,
INT_FACT,
DEC_FACT)

VALUES (

(SELECT

INTER_ID

FROM

CMS_MED_PROV_CHRG.BRIDGE br,
CMS_MED_PROV_CHRG.FACT_TYPE ft

WHERE

br.FACT_TYPE_ID = ft.FACT_TYPE_ID AND
br.PROV_ID = 10001 AND
br.DRG = 39 AND
ft.FACT_TYPE = ‘TOT_DISCH’),

1,
23,
NULL)

Where the SELECT statement retrieves the INTER_ID for the intersection that was defined in the first steps above, 1 is the FACT_TYPE_ID for the FACT_TYPE ‘TOT_DISCH’ and 23 is the value that we are storing as the INT_FACT field. The DEC_FACT field is set to NULL since TOT_DISCH is defined as an integer.

If data is to be updated, the following UPDATE statement can be used:

UPDATE
CMS_MED_PROV_CHRG.FACT
SET

INT_FACT = 23,
DEC_FACT = NULL

WHERE

INTER_ID = (SELECT

INTER_ID

FROM

CMS_MED_PROV_CHRG.BRIDGE br,
CMS_MED_PROV_CHRG.FACT_TYPE ft

WHERE

br.FACT_TYPE_ID = ft.FACT_TYPE_ID AND
br.PROV_ID = 10001 AND
br.DRG = 39 AND
ft.FACT_TYPE = ‘TOT_DISCH’) AND

FACT_TYPE_ID = 1

Where the SELECT statement retrieves the INTER_ID for the intersection that was defined in the first steps above, 1 is the FACT_TYPE_ID for the FACT_TYPE ‘TOT_DISCH’ and 23 is the value that we are storing as the INT_FACT field. The DEC_FACT field is set to NULL since TOT_DISCH is defined as an integer.

Once all of the fact data is populated, a SELECT statement may be devised in order to retrieve the fact data from the data store. To do this, the SELECT statement must join the appropriate dimension tables, FACT_TYPE and FACT tables to the BRIDGE table. The appropriate dimensions (grain) are determined by the value stored in the DIM_LIST field for the fact types:

SELECT

prov.NAME,
drg.DRG,
drg.DRG_DESCR,
prov.STATE,
MAX( CASE WHEN ft.FACT_TYPE = ‘TOT_DISCH’

THEN TRUNCATE(fact.INT_FACT,0)
END)AS ‘TOT_DISCH’,

MAX( CASE WHEN ft.FACT_TYPE = ‘AVG_CVRD_CHGS’

THEN ROUND(fact.DEC_FACT,2)
END ) AS ‘AVG_CVRD_CHRGS’,

MAX( CASE WHEN ft.FACT_TYPE = ‘AVG_TOT_PMTS’

THEN ROUND(fact.DEC_FACT,2)
END ) AS ‘AVG_TOT_PMTS’

FROM

CMS_MED_PROV_CHRG.DRG drg,
CMS_MED_PROV_CHRG.PROVIDER prov,
CMS_MED_PROV_CHRG.BRIDGE bridge,
CMS_MED_PROV_CHRG.FACT fact,
CMS_MED_PROV_CHRG.FACT_TYPE ft

WHERE

bridge.DRG = drg.DRG and
bridge.PROV_ID = prov.PROV_ID and
bridge.FACT_TYPE_ID = ft.FACT_TYPE_ID and
bridge.INTER_ID = fact.INTER_ID and
bridge.FACT_TYPE_ID = fact.FACT_TYPE_ID and
prov.STATE = ‘FL’

GROUP BY

prov.PROV_ID,
drg.DRG

ORDER BY

prov.STATE,

The biggest difference to notice in the above SQL statement is the use of the MAX( ) function, CASE statements and the GROUP BY cause when querying for the actual fact values. The main reason this is necessary, is that many fact types can be stored in a single field in the FACT table. In this case, AVG_CVRD_CHGS and AVG_TOT_PMTS are both stored in the DEC_FACT field of the fact table. As a result, an intersection is defined in this model as a combination of INTER_ID and FACT_{—} TYPE. Therefore, if a query is performed without the grouping, the result will contain three rows for each INTER_ID. The grouping will collapse the result into one row per INTER_ID resulting in a more meaningful result. The CASE statements are present simply to place each result into columns representing each fact type.

Adding a new fact type is a simple matter of creating a new row in the FACT_TYPE table and then populating the fact values using the methods described above. To add a new fact type, execute the following INSERT statement:

INSERT INTO CMS_MED_PROV_CHRG.FACT_TYPE (

FACT_TYPE_ID,
FACT_TYPE,
DIM_LIST,
DESCR,
DATA_TYPE_ID,
RULE_CODE)

VALUES (

NULL,
‘NEW_FACT’,
‘PROVIDER,DRG’,
‘A New Fact’,
‘INT’,
”)

This INSERT statement creates a new row in the FACT_TYPE table. This row contains the following values:
FACT_TYPE_ID—This is an auto incremented value, so it is set to NULL.
FACT_TYPE—This is the mnemonic for this fact type.
DIM_LIST—This is a comma delimited list of the dimensions required to define an intersection at which the fact values will be stored and read.
DESCR—This is a description of what this fact type will hold.
DATA_TYPE_ID—This is a reference to the data type defined in the DATA_TYPE table. This value indicates where to store the fact. In this case, the fact will be stored in the INT_FACT field of the FACT table.
RULE_CODE—This is left blank as this is not a derived fact. Derived facts are discussed in a later section.

The FDIM can store data at multiple grains. This results in a stacked cube approach to multidimensional data. Data with different grains require the intersection of different dimensions. In order to add a fact type that will need a dimension that is not currently stored in this database, the following steps can be performed:
1. The elements needed to describe the domain of data stored in the new dimension need to be identified. A single key unique identifier (surrogate key) should be part of this output in order to keep the bridge table a simple as possible.
2. The new dimension table will need to be created.
3. The BRIDGE table must be modified to contain the surrogate key of the new dimension table and contain a foreign key reference to the new dimension table. This step enables the BRIDGE table to house the new intersection (grain).
4. The new dimension table will need to be populated. This should be done with an ETL tool or bulk loader.
5. The BRIDGE table will need to be populated with the intersections needed to store the facts. This can be done with an ETL tool or bulk loader or the like.
6. The FACT table will need to be populated with the values. This should be done with an ETL tool or bulk loader or the like.

The rules store provides the engine the ability to store rules about how to aggregate dimensions or store formulae that can be saved as derived facts. Rules are collections of conditions, operations, or references to other rules or facts. A derived fact is a collection of operations that will be used to calculate, in real time, a value associated with a given intersection of dimensions.

The Rules Data structure stores the rules that will instruct the engine on how to aggregate facts stored on a hierarchy, or how to calculate a derived fact stored at the intersection of the defined hierarchies. Two types of rules will be stored here: Hierarchical rules and Derived Fact rules. Hierarchy rules are conceptual in that they will not reference or store actual values, but describe how to aggregate values along a hierarchy. Value1 will either be NULL or contain a factor. Value2 will contain either a NULL or a comma delimited list of children to aggregate. A derived fact rule will contain fact types or a fact type and a factor to perform an operation on.

| Field Name | Description |
|---|---|
| RuleCode | This is the unique identifier for a rule. This is a user |
| | defined mnemonic that will identify a rule. |
| BaseRule | This is a Boolean value that determines whether or |
| | not this is a base rule. A base rule is a rule that does |
| | not reference another rule. |
| Value1 | This field can contain a value, a reference to another |
| | field in the FDIM, a comma delimited list of children, |
| | or a fact type that will be used in a derived fact |
| | calculation. This is the left half of a binary operation. |
| Value1Type | This will contain the data type of the data stored in |
| | the Value1 field. These will reference the values |
| | defined in the Value Type Data structure. |
| Value2 | This field can contain a value, a reference to another |
| | field in the FDIM, a comma delimited list of children, |
| | or a fact type that will be used in a derived fact |
| | calculation. This is the right half of a binary |
| | operation. |
| Value2Type | This will contain the data type of the data stored in |
| | the Value1 field. These values will reference the |
| | values defined in the Value Type Data structure. |
| OperatorCode | This field contains the operator code of the binary |
| | operation that will be performed on Value1 and |
| | Value2. These values will reference the values |
| | defined in the Operator Data structure. |
| Description | This is a freeform text field that will contain the user's |
| | definition of this rule. |

The operator data structure contains the list of operators available to a rule. For the most part, this data structure is static and will not change over time. The only time new values will be added will be when new functionality is added to the FDIM and the Calculation Engine.

| Field Name | Description |
|---|---|
| OperatorCode | These are the operator code IDs that are available to a |
| | rule. |
| Description | This field contains the description of what the operator |
| | code does. |

The following is the expected list of operators:

| Operator Code | Description |
|---|---|
| EQ | Equal to |
| NE | Not equal to |
| GT | Greater than |
| GE | Greater than or equal to |
| LT | Less than |
| LE | Less than or equal to |
| IN | Is contained in |
| NI | Is not contained in |
| CN | Contains |
| NC | Does not contain |
| AN | Logical AND |
| OR | Logical OR |
| XO | Logical XOR |
| AD | Add the values |
| SU | Subtract the values |
| MU | Multiply the values |
| DV | Divide the values |
| CT | Count the number of values in Value1 |

The value type data structure contains the list of data types available to a rule. For the most part, this data structure is static and will not change over time. The only time new values will be added will be when new functionality is added to the FDIM and the Calculation Engine. There are three classes of data types: System, Literal and Rule. System data types are references to other fields in the FDIM. Literal values are actual values stored in the value field of the rule data structure. Rule data types are a result of a referenced rule.

| Field Name | Description |
|---|---|
| ValueTypeCode | These are the value type code IDs that are available |
| | to a value contained in a rule. |
| Description | This field contains the description of what the rule |
| | does. |

The following is the expected list of allowed data types:

| ValueTypeCode | Description |
|---|---|
| SYS_BOOL | A Boolean value contained in a referenced field |
| SYS_STRING | A string value contained in a referenced field |
| SYS_LIST | A comma delimited list of values contained in a |
| | referenced field |
| SYS_NUMERIC | A numeric value contained in a referenced field |
| LIT_BOOL | A Boolean value contained in the value field of a rule |
| LIT_STRING | A string value contained in the value field of a rule |
| LIT_LIST | A comma delimited list of values contained in the |
| | value field of a rule |
| LIT_NUMERIC | A numeric value contained in the value field of a rule |
| RUL_BOOL | A Boolean value that is the result of a referenced rule |
| RUL_STRING | A string value that is the result of a referenced rule |
| RUL_LIST | A comma delimited list of values that is the result of a |
| | referenced rule |
| RUL_NUMERIC | A numeric value that is the result of a referenced rule |

Some example rules are listed in the table below.

Rule Table

| | | | | | | Operator | | |
|---|---|---|---|---|---|---|---|---|
| Rule Code | Base Rule | Value1 | Value1 Type | Value2 | Value2 Type | Code | Description | NOTE |
| NOSOCORAT | TRUE | NUMINFECT | SYS_NUMERIC | NUMPAT | SYS_NUMERIC | DV | Nosocomial | This rule is a derived |
| | | | | | | | infection | fact that will take the |
| | | | | | | | rate | NUMINFECT fact and |
| | | | | | | | | divide it by the |
| | | | | | | | | NUMPAT fact. For |
| | | | | | | | | each recorded |
| | | | | | | | | intersection of the |
| | | | | | | | | dimensions. These |
| | | | | | | | | must be of the same |
| | | | | | | | | grain, ie. Have the |
| | | | | | | | | same dimensions. |
| COST | TRUE | SALRATE | SYS_NUMERIC | SUPPCOST | SYS_NUMERIC | AD | Salaries | |
| | | | | | | | and | |
| | | | | | | | supply | |
| | | | | | | | cost total | |
| COSTPAT | FALSE | COST | RUL_NUMERIC | NUMPT | LIT_NUMERIC | DV | Cost per | This derived fact rule |
| | | | | | | | patient | references the COST |
| | | | | | | | | rule for its calculation. |

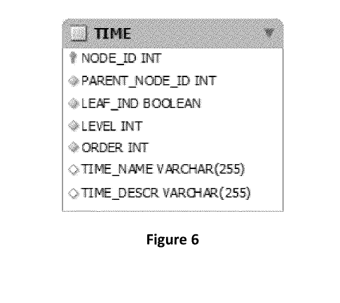

The FDIM can support hierarchical structures (OLAP) in its dimension tables with some minor additions to the base structure. For example see FIG. 6 which depicts a hierarchical structure.

In the above example, a data structure is created to store a time dimension hierarchically. The fields NODE_ID, TIME_NAME and TIME_DESC would be the typical fields that would be used if we were strictly building an FDIM model without hierarchies. Since we want to store a hierarchy, we need to add the PARENT_NODE, LEAF_IND, LEVEL and ORDER fields to the dimension. The fields are defined as follows:

| Field Name | Description |
|---|---|
| NODE_ID | The unique key that identifies a node in the |
| | hierarchy. |
| PARENT_NODE_ID | The NODE_ID if this node's parent. This will be |
| | NULL if this node is at the top of the hierarchy. |
| LEAF_IND | A Boolean value which is set to TRUE if this is |
| | a leaf node. A leaf node has no children. When |
| | loading fact data, only leaf data is to be |
| | populated. All parent nodes will be calculated |
| | at a later time. |
| LEVEL | A numerical value from 0 to n which will tell the |
| | software how to display this node. |
| ORDER | A numerical value from 1 to n which will tell the |
| | software the order to display this node under its |
| | parent. |
| TIME_NAME | The value to display when reporting on this node. |
| TIME_DESC | The description of this node. |

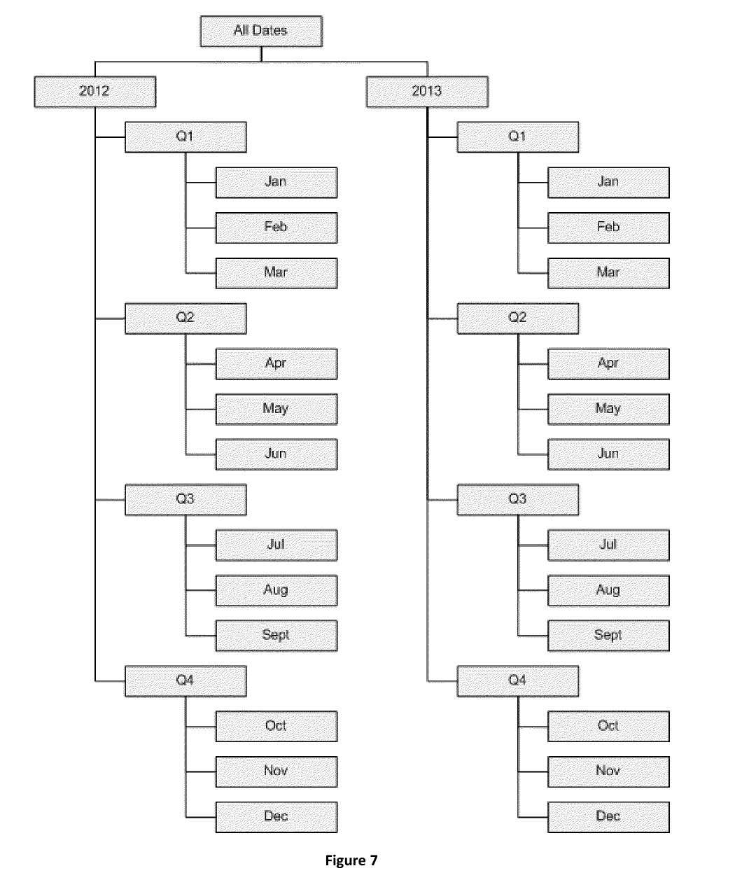

Once the dimension has been created, we will need to determine the hierarchy that we want to load. A typical time hierarchy will look similar to FIG. 7, wherein Q is a quarter.

This hierarchy applied to the time dimension table defined in FIG. 7 will look like this:

| NODE_ID | PARENT_NODE_ID | LEAF_IND | LEVEL | ORDER | TIME_NAME | TIME_DESCR |
|---|---|---|---|---|---|---|
| 1 | NULL | FALSE | 0 | 1 | All Dates | All data. |
| 2 | 1 | FALSE | 1 | 1 | 2012 | All of 2012 |
| 3 | 1 | FALSE | 1 | 2 | 2013 | All of 2013 |
| 4 | 2 | FALSE | 2 | 1 | Q1 | First Quarter 2012 |
| 5 | 2 | FALSE | 2 | 2 | Q2 | Second Quarter 2012 |
| 6 | 2 | FALSE | 2 | 3 | Q3 | Third Quarter 2012 |
| 7 | 2 | FALSE | 2 | 4 | Q4 | Fourth Quarter 2012 |
| 8 | 3 | FALSE | 2 | 1 | Q1 | First Quarter 2013 |
| 9 | 3 | FALSE | 2 | 2 | Q2 | Second Quarter 2013 |
| 10 | 3 | FALSE | 2 | 3 | Q3 | Third Quarter 2013 |
| 11 | 3 | FALSE | 2 | 4 | Q4 | Fourth Quarter 2013 |
| 12 | 4 | TRUE | 3 | 1 | Jan | January 2012 |
| 13 | 4 | TRUE | 3 | 2 | Feb | February 2012 |
| 14 | 4 | TRUE | 3 | 3 | Mar | March 2012 |
| 15 | 5 | TRUE | 3 | 4 | Apr | April 2012 |
| 16 | 5 | TRUE | 3 | 5 | May | May 2012 |
| 17 | 5 | TRUE | 3 | 6 | Jun | June 2012 |
| 18 | 6 | TRUE | 3 | 7 | Jul | July 2012 |
| 19 | 6 | TRUE | 3 | 8 | Aug | August 2012 |
| 20 | 6 | TRUE | 3 | 9 | Sep | September 2012 |
| 21 | 7 | TRUE | 3 | 10 | Oct | October 2012 |
| 22 | 7 | TRUE | 3 | 11 | Nov | November 2012 |
| 23 | 7 | TRUE | 3 | 12 | Dec | December 2012 |
| 24 | 8 | TRUE | 3 | 1 | Jan | January 2013 |
| 25 | 8 | TRUE | 3 | 2 | Feb | February 2013 |
| 26 | 8 | TRUE | 3 | 3 | Mar | March 2013 |
| 27 | 9 | TRUE | 3 | 4 | Apr | April 2013 |
| 28 | 9 | TRUE | 3 | 5 | May | May 2013 |
| 29 | 9 | TRUE | 3 | 6 | Jun | June 2013 |
| 30 | 10 | TRUE | 3 | 7 | Jul | July 2013 |
| 31 | 10 | TRUE | 3 | 8 | Aug | August 2013 |
| 32 | 10 | TRUE | 3 | 9 | Sep | September 2013 |
| 33 | 11 | TRUE | 3 | 10 | Oct | October 2013 |
| 34 | 11 | TRUE | 3 | 11 | Nov | November 2013 |
| 35 | 11 | TRUE | 3 | 12 | Dec | December 2013 |

When all of the dimensions are set up in this fashion the FDIM can function as an OLAP cube. When the intersections of the leaf nodes are populated with data, software can now aggregate the values along the supplied hierarchies.

A Derived Fact is a collection of operations that will be used to calculate, in real time, a value associated with a given intersection of dimensions. Also, a Derived Fact is a fact whose data is not stored in the FDIM. Instead, a rule is referenced from the defined intersections. Rules are collections of conditions, operations, or references to other rules or facts.

Since the reference to a rule is stored at the intersection grain, rules can be defined to behave differently in a subset if intersections exist. This can be useful, especially when the FDIM is set up for hierarchical processing. For example, commission figures for sales associates would only make sense to calculate under the sales branch of the organizational hierarchy, so references to this rule would only be stored.

The implementation of a Derived Fact requires the development of software. This software would be needed in two parts; one for the GUI-based management of rules and derived facts, and the other for the actual real time calculation of the rules and derived facts.

The FDIM provides the capability of storing many multi-dimensional measures at any grain, all within the same database. This allows the stacking of cubes and the sharing of the dimensional data. This ensures that facts stored at different grains with common dimensions are always relevant to each other. The rules engine is comprised of a rules data store and software that is used to store and process rules. Rules tell the software how to process the data. There are two types of rules; hierarchical processing rules, which allows for OLAP like processing, and Derived Fact rules which allow for run-time calculated facts.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the Applicant.

What is claimed is:

1. A data system comprising a single fact data structure having a plurality of fact and a plurality of dimensional data structures capable of adding additional dimensional data structures without having to add additional fact data structures comprising associating the fact data and dimensional data structures together by coupling them each directly to a bridge data structure wherein each dimensional structure is added to the bridge data structure utilizing a dimension key entry in the bridge data structure to associate at least one of the fact data with the dimensional structure.

2. The data system according to claim 1 wherein the data system is at least one of a database data structure and object data structure.

3. A data system according to claim 2 wherein the data system is an open database connectivity database.

4. A data system according to claim 1 which further comprises a rules data store and a software that facilitates the operation and maintenance of the data system.

5. A bridge data structure for use in a data storage system having a single fact data structure and a plurality of dimensional data structures wherein the bridge data structure links the fact data structure and the plurality of dimensional data structures by coupling them each directly to a bridge data structure wherein each dimensional structure is added to the bridge data structure utilizing a dimension key entry in the bridge data structure to associate at least one of the facts with the dimensional structure.
